(19) United States
(12) Patent Application Publication
(10) Pub. No.: US 2003/0126132 A1
(43) Pub. Date: Jul. 3, 2003

(54) Virtual volume management system and method

(76) Inventors: Ravi K. Kavuri, Inver Grove Heights, MN (US); John Chelikowsky, Hopkins, MN (US); Renae M. Weber, MInneapolis, MN (US); Timothy J. Kuik, Lino Lakes, MN (US)

Correspondence Address: Wayne P. Bailey, Storage Technology Corporation, MS-4309, One Storage Tek Drive, Louisville, CO, 80028-4309, US

(21) Appl. No.: 10/033,503

(22) Filed: Dec. 27, 2001

(51) Int. Cl. G06F 7/00

(52) U.S. Cl. 707/10

(57) ABSTRACT

A virtual volume management system and method includes a storage area network having multiple disparate types of storage devices and multiple virtual storage volumes available to a user for use in storage and retrieval of user data. The virtual volume management system and method further include a storage pool linked to at least one of the virtual storage volumes, and a controller for automatically allocating at least two of the storage devices to the pool. The controller partitions and concatenates the storage devices of the pool for storage and retrieval of user data.

### BACKGROUND OF THE INVENTION

1. Field of the Invention

The present invention relates generally to a virtual volume management system and method and, more particularly, to a virtual volume management system and method in a storage area network having a plurality of virtual storage volumes available to a user for use in storage and retrieval of user data.

2. Background

In order to improve data management, a user having multiple physical storage devices, such as magnetic disk drives, may wish to restrict those disks from which storage space may taken to a subset of all possible disks. In that regard, multiple disks can be grouped into sets or “pools.” Without pooling, either a user would not be able to restrict those physical disks from which storage space is taken, or the user would have to specify a list of physical disks from which the user would allow storage space to be taken every time the user wanted to perform any operation involving storage.

Thus, pooling is a way to specify a set of physical disks, and abstract the set as a single entity. Using pooling, when a logical disk is created, a user can specify a single pool of physical disks from which storage space is to be taken, rather than needing to enumerate all physical disks that might be acceptable. One operation that can be performed using pooling is the creation of one or more logical or “virtual” storage device. In such a fashion, a single virtual disk may be presented to a user, while multiple pooled physical disks are specified and employed for actual storage of the user's data.

In that regard, it is known to use disk pooling in a Redundant Array of Independent/Inexpensive Disks (RAID). As is well known in the art, a RAID device or box typically includes multiple physical disk drives, as well as an internal controller which pools the multiple disks and presents a single virtual disk to a user.

There are, however, various problems associated with disk pooling in a RAID. First, a RAID box involves pooling of a fixed number of disks that are captive within an enclosure. As a result, storage capacity with a RAID enclosure is only as extensible as the physical enclosure with its fixed number of disks allows. While larger RAID enclosures may be manufactured with more disks, a limit always exists on the number of disks that can ultimately be included. That is, an arbitrarily large physical enclosure is simply not possible. Similarly, while existing RAID enclosure may be stocked with disks having greater storage capacity, it is not certain that a user's storage capacity requirements can continually be met by such “denser” RAID enclosures.

Thus, there exists a need for a system and method for managing virtual storage volumes that overcomes the problems described above relating to RAID enclosures. Such a system and method would employ open disk pooling, thereby enabling disk pooling in a network environment, such as in a storage area network (SAN). Such a virtual volume management system and method would be capable of operating with disparate types of storage devices, such as physical disks, RAID enclosures, as well as virtual disks. Still further, such a virtual volume management system and method would provide for open disk pooling in a SAN without adversely affecting network performance.

### SUMMARY OF THE INVENTION

Accordingly, it is an object of the present invention to provide a virtual volume management system and method in a storage area network having a plurality of virtual storage volumes available to a user for use in storage and retrieval of user data.

According to the present invention, then, in a storage area network having a plurality of virtual storage volumes available to a user for use in storage and retrieval of user data, a system is provided for managing the plurality of virtual storage volumes. The system comprises a plurality of storage devices, the plurality of storage devices comprising first and second sets of storage devices, wherein the first set of storage devices is of a type different than the second set of storage devices, and a controller for automatically grouping at least two of the plurality of storage devices into a pool and linking at least one of the plurality of virtual storage volumes to the pool. The controller partitions and concatenates the at least two of the plurality of storage devices for storage of user data thereto and retrieval of user data therefrom.

Still further according to the present invention, in a storage area network having a plurality of virtual storage volumes available to a user for use in storage and retrieval of user data, a method is provided for managing the plurality of virtual storage volumes. The method comprises providing a plurality of storage devices, the plurality of storage devices comprising first and second sets of storage devices, wherein the first set of storage devices is of a type different than the second set of storage devices, and providing a controller for automatically grouping at least two of the plurality of storage devices into a pool and linking at least one of the plurality of virtual storage volumes to the pool. The controller partitions and concatenates the at least two of the plurality of storage devices for storage of user data thereto and retrieval of user data therefrom.

According to another embodiment of the present invention, a virtual volume management system is provided. The virtual volume management system comprises a storage area network comprising a plurality of storage devices and a plurality of virtual storage volumes available to a user for use in storage and retrieval of user data, the plurality of storage devices comprising first and second sets of storage devices, wherein the first set of storage devices is of a type different than the second set of storage devices. The virtual volume management system further comprises a storage pool linked to at least one of the plurality of virtual storage volumes, and a controller for automatically allocating at least two of the plurality of storage devices to the pool. The controller partitions and concatenates the at least two of the plurality of storage devices for storage of user data thereto and retrieval of user data therefrom.

Still further according to another embodiment of the present invention, a virtual volume management method is provided. The virtual volume management method comprises providing a storage area network comprising a plurality of storage devices and a plurality of virtual storage volumes available to a user for use in storage and retrieval of user data, the plurality of storage devices comprising first and second sets of storage devices, wherein the first set of storage devices is of a type different than the second set of storage devices. The virtual volume management method further comprises providing a storage pool linked to at least one of the plurality of virtual storage volumes, and providing a controller for automatically allocating at least two of the plurality of storage devices to the pool. The controller partitions and concatenates the at least two of the plurality of storage devices for storage of user data thereto and retrieval of user data therefrom.

These and other features and advantages of the present invention are readily apparent from the following detailed description of the present invention when taken in connection with the accompanying drawings.

### BRIEF DESCRIPTION OF THE DRAWINGS

FIG. 1 is a simplified block diagram depicting an exemplary disk pooling instance;

FIG. 2 is a simplified, exemplary block diagram of a RAID enclosure;

FIG. 3 is a simplified block diagram depicting the virtual volume management system of the present invention;

FIG. 4 is simplified block diagram depicting another aspect of the virtual volume management system of the present invention;

FIG. 5 is a simplified, representative flow chart depicting one embodiment of the virtual volume management method of the present invention; and

FIG. 6 is a simplified, representative flow chart depicting another embodiment of the virtual volume management method of the present invention.

### DETAILED DESCRIPTION OF THE PREFERRED EMBODIMENT(S)

Referring now to the Figures, the preferred embodiments of the present invention will now be described in detail. As previously noted, in order to improve data management, a user having multiple physical storage devices, such as magnetic disk drives, may wish to restrict those disks from which storage space may taken to a subset of all possible disks. In that regard, multiple disks can be grouped into sets or “pools.” Without pooling, either a user would not be able to restrict those physical disks from which storage space is taken, or the user would have to specify a list of physical disks from which the user would allow storage space to be taken every time the user wanted to perform any operation involving storage.

Thus, pooling is a way to specify a set of physical disks, and abstract the set as a single entity. Using pooling, when a logical disk is created, a user can specify a single pool of physical disks from which storage space is to be taken, rather than needing to enumerate all physical disks that might be acceptable. One operation that can be performed using pooling is the creation of one or more logical or “virtual” storage device. In such a fashion, a single virtual disk may be presented to a user, while multiple pooled physical disks are specified and employed for actual storage of the user's data.

In that regard, it is known to use disk pooling in a Redundant Array of Independent/Inexpensive Disks (RAID). As is well known in the art, a RAID device or box typically includes multiple physical disk drives, as well as an internal controller which pools the multiple disks and presents a single virtual disk to a user.

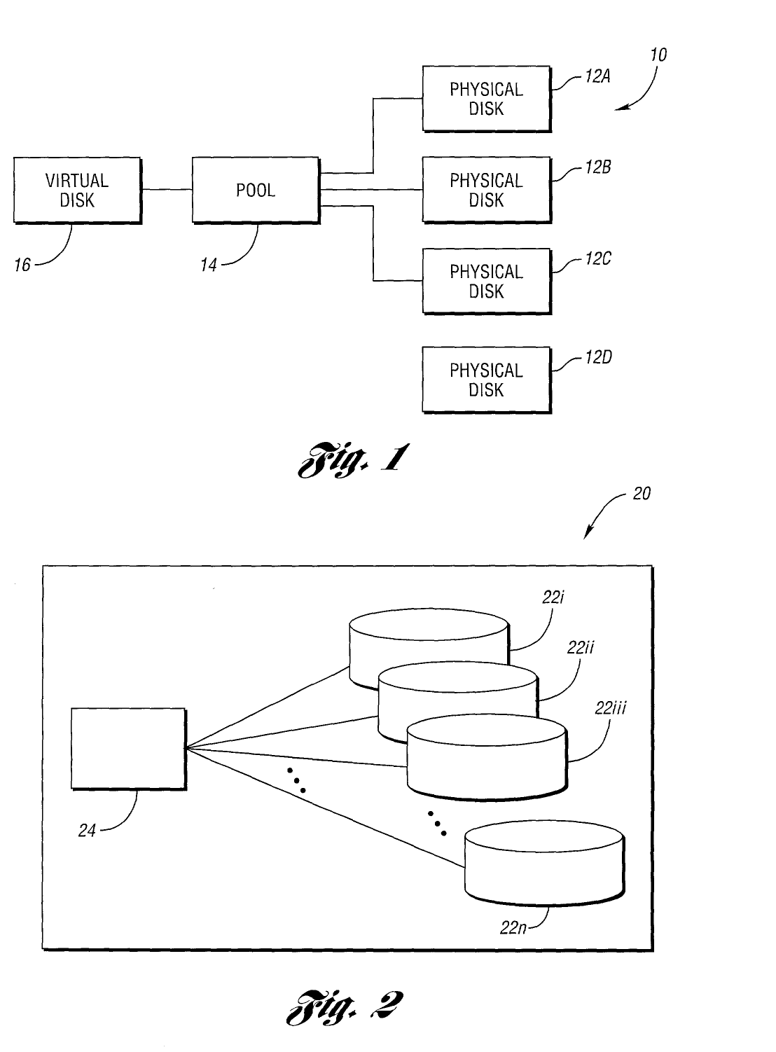

Referring now to FIG. 1, an exemplary disk pooling instance is shown in a simplified block diagram form, such as may be embodied in a RAID enclosure, and is denoted generally by reference numeral 10. As seen therein, multiple physical magnetic disk drives are denoted by reference numerals 12A, 12B, 12C and 12D, respectively. Disk pooling instance (10) includes a subset (12A, 12B, 12C) of those multiple physical disks (12A, 12B, 12C, 12D). In particular, a subset of physical disks (12A, 12B, 12C) is grouped or allocated to a pool (14). A virtual disk (16) is provided in communication with pool (14). As a result of the pooling, virtual disk (16) can obtain storage space only from physical disks (12A, 12B, 12C). That is, virtual disk (16) is restricted to taking storage space from physical disks (12A, 12B, 12C), and cannot obtain storage space from physical disk (12D).

As previously noted, the disk pooling instance (10) illustrated in FIG. 1 may be embodied in a RAID enclosure. Referring now to FIG. 2, a simplified, exemplary block diagram of such a RAID enclosure is shown, denoted generally by reference numeral 20. As seen in FIG. 2, RAID enclosure (20) includes multiple physical disk drives (22i, 22ii, 22iii, . . . 22n), as well as an internal controller (24). As is well known in the art, controller (24) pools the multiple disks (22i, 22ii, 22iii, . . . 22n) in order to present a single virtual disk (not shown).

As also previously noted, however, there are various problems associated with disk pooling in RAID enclosure (20). First, RAID enclosure (20) involves pooling of a fixed number of disks (22i, 22ii, 22iii, . . . 22n) that are captive within the RAID enclosure (20). As a result, storage capacity with RAID enclosure (20) is only as extensible as the physical enclosure with its fixed number of disks (22i, 22ii, 22iii, . . . 22n) allows. While larger RAID enclosures may be manufactured with more disks, a limit always exists on the number of disks that can ultimately be included. That is, an arbitrarily large physical enclosure is simply not possible. Similarly, while existing RAID enclosure (20) may be stocked with disks having greater storage capacity, it is not certain that a user's storage capacity requirements can continually be met by such “denser” RAID enclosures.

Thus, as noted above, there exists a need for a system and method for managing virtual storage volumes that overcomes the problems described above relating to RAID enclosures. Such a system and method would employ open disk pooling, thereby enabling disk pooling in a network environment, such as in a storage area network (SAN). In that regard, however, a number of problems arise in applying disk pooling in a SAN environment. First, it becomes unwieldy to manage configurations in a SAN which are segmented by boundaries, such as in a RAID enclosure. Similarly, a variety of devices and device manufacturers make seamless operation and management of such devices in a SAN difficult. Thus, a virtual volume management system and method in a SAN environment would preferably provide a single interface for an arbitrarily large number of disparate types of SAN devices, such as physical disks, RAID enclosures, as well as virtual disks.

In that regard, each disk product usually has peculiarities which make it different from other disk products. An example of this is that different manufacturers may identify disks in different ways. More specifically, one manufacturer might identify its disks with a unique serial number string, while another manufacturer might identify its disks via a World Wide Name. Moreover, each identification may appear in a different location (SCSI mode page) in a different format for any given disk. Another example of peculiarities between disk products is that, for performance reasons, different RAID controllers tends to have different solutions to cache data destined for disk in RAM. In that regard, different RAID controllers have different requirements as to which of multiple ports may be used at any given time. At a minimum, failure to comply with such requirements ruins the data caching scheme, and therefore hurts RAID controller performance. At worst, failure to comply with such requirements could cause corruption of the user's data.

It is therefore common for each disk manufacturer to require that a special software driver be installed on every server which wishes to access that manufacturer's disk. The software drivers handle the peculiarities of how the disks are identified, and what the rules for routing data may be. If a user wishes to employ a different disk product for any reason (e.g., newer, cheaper, faster, etc.), the user must identify which servers will use the disk, and then install the appropriate software driver on all such servers. That is, every time a user wishes to add a new disk product, the user must install new drivers on the user's servers.

As a result, for disk pooling in a SAN, to solve the problem faced by an end user of needing to install new drivers on every server every time a new kind of disk is added, the intelligence which is normally captured in each driver (e.g., for identifying each type of disk product, for coping with data caching) must be provided. More particularly, for disk pooling in a SAN, devices can be renamed, or a consistent naming scheme can be employed so that a single disk driver in a server on the front end of the SAN will allow the use of all types of supported back-end disks. The rules concerning which ports may be used at any given time can be followed. That is, the differences between each of a variety of disk products are learned and handled accordingly, so that such differences are not apparent to an end user.

The present invention thus may provide for naming or routing directly. More importantly, however, the present invention provides the novel solution of a single point or interface where the differences between disk products are automatically accounted for without involving an end user so that a single pool may include disks from different manufacturers or different RAID controllers. In that regard, disk pooling previously existed only in RAID boxes, which required homogeneous disks. According to the present invention, however, a user need not add a new driver to every server in the user's data center. That is, provided the manufacturer's disk is supported, it can simply be plugged into the SAN. Even if the disk is not currently supported, the user need only update the single interface of the present invention when an appropriate update for support of the disk can be obtained, rather than multiple servers.

Still further, disk pooling in a SAN requires the addition of such appropriate intelligence to the network in a way which does not hinder application performance. In that regard, the addition of such intelligence through software implemented in existing SAN elements can adversely affect data throughput, or the speed at which data is routed in the network. A virtual volume management system and method would preferably provide for open disk pooling in a SAN through the addition of such intelligence in the form of separate means for controlling disk pooling, which may be appropriate hardware and/or software, so as not to adversely affect network performance. In that regard, the intelligence for such disk pooling is similar to the intelligence known to those of ordinary skill in the art for disk pooling in a RAID environment, with the exception of problems such as those described above that arise when disk pooling is undertaken in a network environment, such as a SAN.

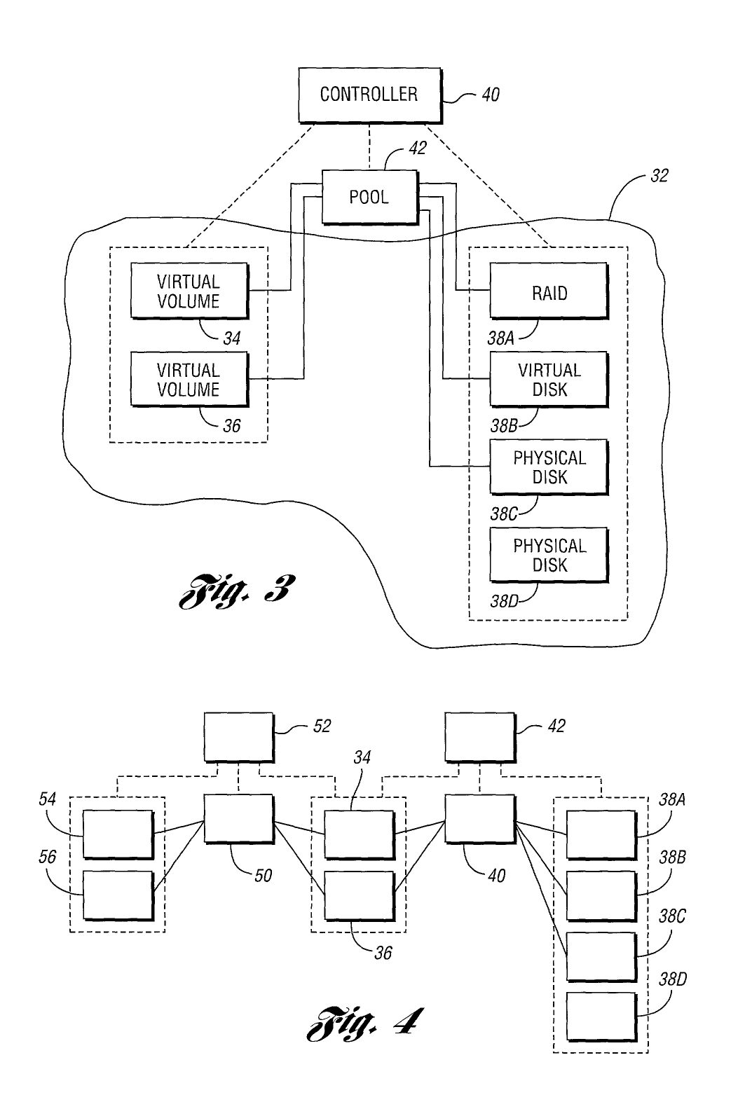

Referring now to FIG. 3, a simplified block diagram depicting the virtual volume management system of the present invention is shown, denoted generally by reference numeral 30. As seen therein, a storage area network (32) is provided. Storage area network (32) comprises a plurality of virtual storage volumes (34, 36) available to a user (not shown) for use in storage and retrieval of user data. A plurality of storage devices (38A, 38B, 38C and 38D) are also provided which, as depicted in FIG. 3, may be part of storage area network (32). While not shown in FIG. 3, those of ordinary skill in the art will appreciate that storage area network (32) still further includes various other well known elements, such as switches, hubs and servers (not shown), at least some of which may be required for proper operation of the network.

Still referring to FIG. 3, a controller (40) is provided for automatically allocating at least two of the plurality of network storage devices (storage devices (38A, 38B, 38C) as shown in FIG. 3) to a storage pool (42) and for linking at least one of the plurality of virtual storage volumes (virtual storage volumes (34, 36) as shown in FIG. 3) to the pool (42). Controller (40) also performs other known functions associated with disk pooling. In that regard, controller (40) partitions and concatenates the network storage devices (38A, 38B, 38C) allocated to the pool (42) for storage of user data thereto and retrieval of user data therefrom. Notably, controller (40), which preferably comprises a plurality of parallel processors, but which may also be implemented in whole or in part through software, performs such disk pooling inside of storage area network (32) (i.e., outside of a RAID enclosure or a server). Thus, as a result of the pooling, virtual storage volumes (34, 36) can obtain storage space only from network storage devices (38A, 38B, 38C). That is, virtual storage volumes (34, 36) are restricted to taking storage space from network storage devices (38A, 38B, 38C), and cannot obtain storage space from network storage device (38D). As is readily apparent from the foregoing description, in contrast to disk pooling in a RAID enclosure, according to the virtual volume management system (30) of the present invention is extensible. That is, whenever a user or an application requires additional disk storage space in the SAN, that need can be readily addressed by the addition of one or more additional storage devices to the appropriate pool.

In contrast to disk pooling in a RAID enclosure, network storage devices (38A, 38B, 38C, 38D) in the virtual volume management system (10) of the present invention may take various forms. For example, as seen in FIG. 3, storage devices (38A, 38B, 38C, 38D) may comprise a physical magnetic disk drive (38C, 38D), a RAID enclosure (38A) as previously described, a virtual storage volume, such as virtual disk (38B), or any combination thereof.

In such a fashion, tiering of the virtual volume management system of the present invention is possible. In that regard, referring to FIG. 4, a simplified block diagram depicting such an aspect of the virtual volume management system of the present invention is shown. In that regard, it should be noted that FIG. 4 depicts many of the same elements of a virtual volume management system depicted in FIG. 3, which elements are denoted in FIG. 4 with like reference numerals.

As seen in FIG. 4, and with continuing reference to FIG. 3, virtual storage volumes (34, 36) may themselves be allocated to a storage pool (50). More particularly, a controller (52) may be provided for automatically allocating one or both of virtual storage volumes (34, 36) to pool (50) and for linking at least one of a plurality of virtual storage volumes (54, 56) to pool (50). In that regard, controller (52) again partitions and concatenates the virtual volumes (34, 36) allocated the pool (50) for storage of user data thereto and retrieval of user data therefrom. In such a fashion, as a result of the pooling, virtual storage volumes (54, 56) can be restricted to taking storage space from virtual storage volumes (34, 36). In that regard, it should be noted that such tiering could rely upon virtualization provided by a RAID enclosure and/or SAN virtualization as described herein.

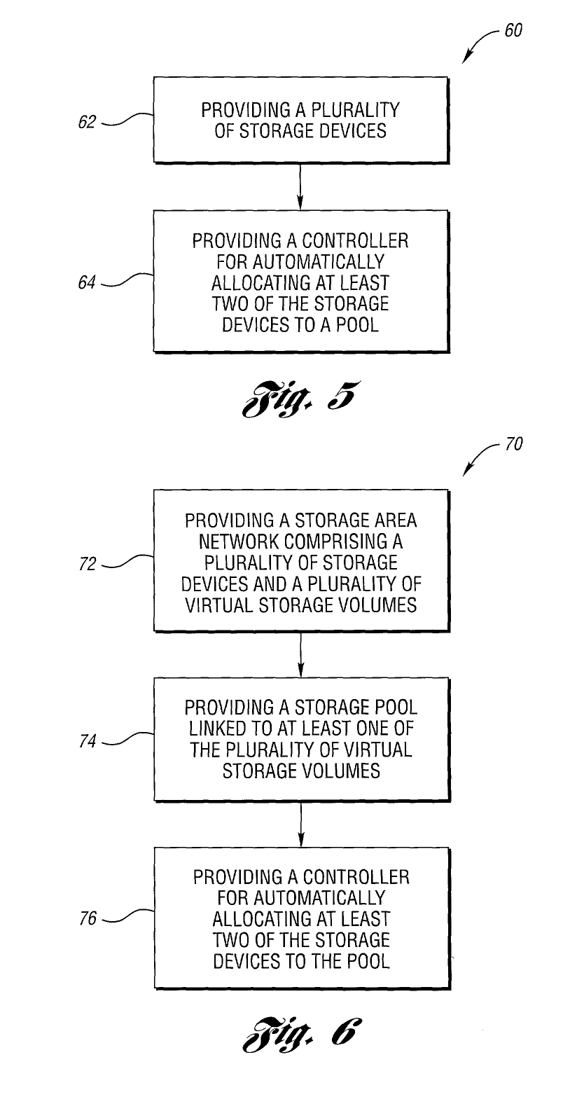

Referring now to FIG. 5, a simplified, representative flow chart depicting one embodiment of the virtual volume management method of the present invention is shown, denoted generally by reference numeral 60. As seen therein, according to the present invention, in a storage area network having a plurality of virtual storage volumes available to a user for use in storage and retrieval of user data, a method (60) is provided for managing the plurality of virtual storage volumes. The virtual volume management method (60) comprises providing (62) a plurality of storage devices, the plurality of storage devices comprising first and second sets of storage devices, wherein the first set of storage devices is of a type different than the second set of storage devices, and providing (64) a controller for automatically allocating at least two of the plurality of storage devices to a pool and linking at least one of the plurality of virtual storage volumes to the pool. In that regard, according to the virtual volume management method (60) of the present invention, the controller partitions and concatenates the at least two of the plurality of storage devices for storage of user data thereto and retrieval of user data therefrom.

As previously described, in contrast to disk pooling in a RAID enclosure, the storage devices used according to the virtual volume management method (60) of the present invention may take various forms. For example, such storage devices may comprise a physical magnetic disk drive, a RAID enclosure as previously described, a virtual storage volume, such as a virtual disk, or any combination thereof.

Referring next to FIG. 6, a simplified, representative flow chart depicting another embodiment of the virtual volume management method of the present invention is shown, denoted generally by reference numeral 70. As seen therein, the virtual volume management method (70) comprises providing (72) a storage area network comprising a plurality of storage devices and a plurality of virtual storage volumes available to a user for use in storage and retrieval of user data, the plurality of storage devices comprising first and second sets of storage devices, wherein the first set of storage devices is of a type different than the second set of storage devices, and providing (74) a storage pool linked to at least one of the plurality of virtual storage volumes. The virtual volume management method (70) still further comprises providing (76) a controller for automatically allocating at least two of the plurality of storage devices to the pool. Again according to the virtual volume management method (70) of the present invention, the controller partitions and concatenates the at least two of the plurality of storage devices for storage of user data thereto and retrieval of user data therefrom.

Once again, as described above, in contrast to disk pooling in a RAID enclosure, the storage devices used according to the virtual volume management method (70) of the present invention may take various forms. For example, such storage devices may comprise a physical magnetic disk drive, a RAID enclosure as previously described, a virtual storage volume, such as a virtual disk, or any combination thereof.

It should be noted that the simplified flowcharts depicted in FIGS. 5 and 6 are exemplary of the virtual volume management method of the present invention. In that regard, the steps of such method may be executed in sequences other than those shown in FIGS. 5 and 6, including the execution of one or more steps simultaneously.

As is readily apparent from the foregoing description, the present invention provides a virtual volume management system and method for use in a in a storage area network having a plurality of virtual storage volumes available to a user for use in storage and retrieval of user data. In that regard, the virtual volume management system and method of the present invention overcomes the disk pooling problems described above relating to RAID enclosures. The system and method of the present invention employ open disk pooling, thereby enabling disk pooling in a network environment, such as in a storage area network (SAN). The virtual volume management system and method of the present invention are capable of operating with disparate types of storage devices, such as physical disks, RAID enclosures, as well as virtual disks. Still further, the virtual volume management system and method of the present invention provide for open disk pooling in a SAN without adversely affecting network performance.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. In a storage area network having a plurality of virtual storage volumes available to a user for use in storage and retrieval of user data, a system for managing the plurality of virtual storage volumes comprising:
a plurality of storage devices, the plurality of storage devices comprising first and second sets of storage devices, wherein the first set of storage devices is of a type different than the second set of storage devices; and
a controller for automatically allocating at least two of the plurality of storage devices to a pool and linking at least one of the plurality of virtual storage volumes to the pool, wherein the controller partitions and concatenates the at least two of the plurality of storage devices for storage of user data thereto and retrieval of user data therefrom.

2. The system of claim 1 wherein the plurality of storage devices comprises at least one physical disk.

3. The system of claim 1 wherein the plurality of storage devices comprises at least one redundant array of independent disks.

4. The system of claim 3 wherein the plurality of storage devices comprises at least one virtual storage volume.

5. The system of claim 4 wherein the at least one virtual storage volume comprises at least one virtual disk.

6. In a storage area network having a plurality of virtual storage volumes available to a user for use in storage and retrieval of user data, a method for managing the plurality of virtual storage volumes comprising:
providing a plurality of storage devices, the plurality of storage devices comprising first and second sets of storage devices, wherein the first set of storage devices is of a type different than the second set of storage devices; and
providing a controller for automatically allocating at least two of the plurality of storage devices to a pool and linking at least one of the plurality of virtual storage volumes to the pool, wherein the controller partitions and concatenates the at least two of the plurality of storage devices for storage of user data thereto and retrieval of user data therefrom.

7. The method of claim 6 wherein the plurality of storage devices comprises at least one physical disk.

8. The method of claim 6 wherein the plurality of storage devices comprises at least one redundant array of independent disks.

9. The method of claim 8 wherein the plurality of storage devices comprises at least one virtual storage volume.

10. The method of claim 9 wherein the at least one virtual storage volume comprises at least one virtual disk.

11. A virtual volume management system comprising:
a storage area network comprising a plurality of storage devices and a plurality of virtual storage volumes available to a user for use in storage and retrieval of user data, the plurality of storage devices comprising first and second sets of storage devices, wherein the first set of storage devices is of a type different than the second set of storage devices;
a storage pool linked to at least one of the plurality of virtual storage volumes; and
a controller for automatically allocating at least two of the plurality of storage devices to the pool, wherein the controller partitions and concatenates the at least two of the plurality of storage devices for storage of user data thereto and retrieval of user data therefrom.

12. The system of claim 11 wherein the plurality of storage devices comprises at least one physical disk.

13. The system of claim 11 wherein the plurality of storage devices comprises at least one redundant array of independent disks.

14. The system of claim 13 wherein the plurality of storage devices comprises at least one virtual storage volume.

15. The system of claim 14 wherein the at least one virtual storage volume comprises at least one virtual disk.

16. A virtual volume management method comprising:
providing a storage area network comprising a plurality of storage devices and a plurality of virtual storage volumes available to a user for use in storage and retrieval of user data, the plurality of storage devices comprising first and second sets of storage devices, wherein the first set of storage devices is of a type different than the second set of storage devices;
providing a storage pool linked to at least one of the plurality of virtual storage volumes; and
providing a controller for automatically allocating at least two of the plurality of storage devices to the pool, wherein the controller partitions and concatenates the at least two of the plurality of storage devices for storage of user data thereto and retrieval of user data therefrom.

17. The method of claim 16 wherein the plurality of storage devices comprises at least one physical disk.

18. The method of claim 16 wherein the plurality of storage devices comprises at least one redundant array of independent disks.

19. The method of claim 18 wherein the plurality of storage devices comprises at least one virtual storage volume.

20. The method of claim 19 wherein the at least one virtual storage volume comprises at least one virtual disk.
